(19) United States
(12) Patent Application Publication
(10) Pub. No.: US 2002/0136859 A1
(43) Pub. Date: Sep. 26, 2002

(54) Antistatic Yarn, Fabric, Carpet and Fiber Blend Formed From Conductive or Quasi-Conductive Staple Fiber

(75) Inventors: W. Keith Fisher, Suffield, CN (US); John J. Elliot, Pensacola, FL (US)

Correspondence Address: Craig Lundell, Carter J. White, HOWREY SIMON ARNOLD & WHITE LLP, 750 Bering Dr., Houston, TX, 77057, US, 713.787.1400

(73) Assignee: SOLUTIA INC., St. Louis, 63141 (US)

(21) Appl. No.: 09/586,201

(22) Filed: Jun. 2, 2000

Related U.S. Application Data
(60) Provisional application No. 60/137,615, filed on Jun. 3, 1999.

(51) Int. Cl. D05C 17/00; D02G 3/02; D02G 3/36; B32B 33/00

(52) U.S. Cl. 428/95; 428/97; 428/359; 428/361; 428/373; 428/374; 428/375; 428/379; 428/389; 57/252; 57/255; 57/257

(57) ABSTRACT

### Abstract of Disclosure

Antistatic yarns, fabrics and carpets incorporating such antistatic yarns, and fiber blends for making such antistatic yarns are disclosed wherein the antistatic yarns are formed such that at least about 35 percent by weight of the staple fibers present are conductive staple fibers, quasi-conductive staple fibers, or mixtures of conductive and quasi-conductive staple fibers. Conductive staple fibers may include metal staple fibers, metal-coated non-conductive polymer staple fibers, carbon-loaded polymer staple fibers, polymer staple fibers loaded with antimony-doped tin oxide, conductive polymer solution-coated non-conductive polymer staple fibers, inherently-conductive polymer staple fibers, and bicomponent staple fibers. Quasi-conductive staple fibers may include bicomponent quasi-conductive staple fibers. Continuous fibers and non-conductive staple fibers may also be present.

### Cross Reference to Related Applications

This application claims the benefit of U.S. Provisional Application Serial No. 60/137,615, filed June 3, 1999.

### Background of Invention

Field of Invention: This invention is directed toward antistatic yarns, as well as to the fiber blends from which such yarns are made and the antistatic fabrics and carpets into which such yarns may be incorporated. More specifically, the present invention is directed toward antistatic yarns where about 35 percent or more by weight of all the individual staple fibers present are conductive or quasi-conductive staple fibers.

Background: It is well known that the generation and uncontrolled discharge of static electrical charge can be problematic in many fields.

In one example, static charge can accumulate in flexible containers such as flexible intermediate bulk containers (FIBCs). Containers formed of flexible fabric are used widely in commerce to carry free-flowing materials in bulk quantities. Flexible intermediate bulk containers are typically used to carry and deliver finely-divided solids such as cement, fertilizers, salt, sugar and grains. The fabric from which such FIBCs are generally constructed is a weave of one or more synthetic polymer materials, e.g., a polyolefin such as polypropylene. This fabric may optionally be coated with a similar polymer material on one or both sides. If such a coating is applied, the fabric may become non-porous, while fabric without such coating will usually be porous. The usual configuration of such FIBCs involves a rectilinear or cylindrical body having a wall, base, cover, and a closable spout extending from the base or from the top or both.

Crystalline (isotactic) polypropylene is a particularly useful material from which to fabricate monofilament, multifilament or flat tape yarns for use in the construction of woven fabrics for FIBCs. In weaving fabrics of polypropylene, it is the practice to orient the yarns monoaxially. Such yarns may be of rectangular or circular cross-section. This is usually accomplished by hot-drawing, so as to irreversibly stretch the yarns and thereby orient their molecular structure. Fabrics of this construction are exceptionally strong, light-weight, and stable. Examples of such fabrics used in FIBCs are well-known in the art and are disclosed in U.S. Pat. Nos. 3,470,928; 4,207,937; 4,362,199 and 4,643,119.

It has long been observed that static electrical charge can accumulate in FIBCs and other containers. This accumulation is thought to take place as a result of the shifting and other movement between particles and between particles and the walls of the container. For example, the generation of static charge has been observed on the walls and in the contents of FIBCs during the filling, unfilling, and movement of such containers. This accumulation has also been observed to take place to a greater extent in environments of lower relative humidity.

Discharges of accumulated static electrical charge may be dangerous if they are of sufficient energy to be incendiary. That is, a discharge of sufficient energy may be able to initiate the ignition of combustible materials present in dusty atmospheres or flammable vapor atmospheres. Discharges of accumulated static charge may also be uncomfortable to workers handling such containers.

In another example, static electrical charge is known to be generated and transferred to a person walking on conventional carpet structures. When the person walking across such surfaces later becomes grounded, accumulated charge flows through that part of the person"s body which by chance comes in contract with the grounded object. When the grounded object is a metal door knob or metal cabinet, the resulting electrical shock can be discomforting to many people. When the grounded object is a computer or other electronic equipment, the resulting discharge can permanently damage the sensitive electronic and microelectronic components contained within these devices.

In a third example, undesired static charge is known to build up in the fabric of many types of apparel. Such accumulated static electrical charge may cause a garment to cling to itself and other adjacent articles of clothing, resulting in annoyance of the wearer. Such charge is also thought to accelerate the soiling of the garment by attracting airborne dust and dirt. Moreover, in order to prevent damage to sensitive electronic and microelectronic parts during their manufacture and processing, there continues to be a real need to minimize static charge on apparel for work uniforms worn by people in the electronics industry. Also, the accumulation of static electrical charge must be minimized on apparel worn by people working within potentially explosive environments.

Other examples of the problems associated with the unwanted accumulation of static electricity are readily known to those skilled in the art.

There continues to exist a real need for improved yarns, fabrics, fabric containers and carpets that are capable of effectively preventing the accumulation and resulting high-energy discharge of static electrical charge.

### Summary of Invention

The present invention is generally related to antistatic yarns, as well as to the fiber blends from which such yarns are made and the antistatic fabrics and carpets into which such yarns may be incorporated. More specifically, the present invention comprises antistatic yarns whereby about 35 percent or more by weight of the staple fibers present are conductive, quasi-conductive staple fibers, or mixtures of conductive and quasi-conductive staple fibers.

In one set of embodiments of the present invention, the antistatic yarn contains staple fibers whereby about 35 percent or more by weight of the staple fibers present are conductive staple fibers. Suitable conductive staple fibers include metal staple fibers, metal-coated non-conductive polymer staple fibers, carbon-loaded polymer staple fibers, polymer staple fibers loaded with antimony-doped tin oxide, conductive polymer solution-coated non-conductive polymer staple fibers, inherently-conductive polymer staple fibers, and bicomponent staple fibers.

In a second set of embodiments of the present invention, the antistatic yarn contains staple fibers whereby about 35 percent or more by weight of the staple fibers present are quasi-conductive staple fibers, including bicomponent quasi-conductive staple fibers.

In a third set of embodiments of the present invention, the antistatic yarn contains staple fibers whereby about 35 percent or more by weight of the staple fibers present are a mixture of conductive staple fibers and quasi-conductive staple fibers.

In each of the above three sets of embodiments of the present invention, the antistatic yarn may also contain continuous fibers and/or non-conductive staple fibers.

In still other embodiments of the present invention, the above antistatic yarns are present in antistatic fabrics and carpets. Further still, in another embodiment of the present invention, the antistatic yarns are present in flexible intermediate bulk containers.

### Detailed Description

This invention is directed towards antistatic yarns, as well as to the fiber blends from which such yarns are made and the antistatic fabrics and carpets into which such yarns may be incorporated. The present invention more specifically comprises antistatic yarns where about 35 percent or more of the individual staple fibers present are conductive staple fibers, quasi-conductive staple fibers, or a mixture of conductive and quasi-conductive staple fibers. It will be understood that the term yarn, as used herein, is employed consistent with its ordinary meaning to those skilled in the art and may comprise one fiber or two or more individual fibers twisted together in such a way as to enable the yarn to be subject to further physical manipulation. Likewise, it will be understood that the terms staple and continuous, as applied to the fibers from which yarns may be manufactured, are employed consistent with their ordinary meaning to those skilled in the art. Moreover, the art is well-versed in suitable methods of combining different types of staple fibers, as well as combining staple fibers and continuous fibers, to form suitable yarns having predictable physical strength and elongation properties. An overview of such combination techniques is provided in Hudson, Peyton B., et al, Joseph"s Introductory Textile Science, 6th ed., Ch. 16, 19 Harcourt Brace Jovanovich College Publishers, N.Y., the disclosure of which is incorporated herein by reference.

First Set of Embodiments: In a first embodiment of the present invention, the antistatic yarn is made entirely from staple fibers. According to this embodiment, about 35 percent or more by weight of fibers are conductive staple fibers. The balance of staple fibers, if any, may be non-conductive staple fibers. Standard processing techniques commonly used to manufacture spun yarn from different types of staple fibers, for example, ring spinning, may be employed to make antistatic yarn according to this embodiment.

Conductive staple fibers, as used herein, include those fibers in which each individual fiber has a direct current (DC) linear resistance of less than about 10⁹ ohms per centimeter. Suitable conductive staple fibers include metal staple fibers, metal-coated non-conductive polymer staple fibers, carbon-loaded polymer staple fibers, polymer staple fibers loaded with antimony-doped tin oxide, conductive polymer solution-coated non-conductive polymer staple fibers, inherently-conductive polymer staple fibers, and bicomponent conductive staple fibers.

Suitable metal staple fibers include those made from stainless steel, copper, aluminum, steel, iron, tin, brass, or other metallic materials. Other suitable conductive staple fibers include those made from metal-coated fibers of non-conductive polymer. An example of such fibers is the silver-coated nylon fiber product made and sold by Sauquoit Industries of Scranton, Pennsylvania. While metal and metal-coated non-conductive polymer staple fibers are suitable for the present invention, they typically have very low electrical linear resistances and have a tendency to produce high-energy spark discharges rather than the low-energy discharges characteristic of carbon-loaded conductive fibers. Thus, metal and metal-coated non-conductive polymer staple fibers are less preferred.

Preferred conductive staple fibers include those made from carbon-loaded polymer. The techniques and methods used to introduce carbon (graphite) into a normally non-conductive polymer, such as, for example nylon, are well known in the art. Such introduction of carbon reduces the resistivity of the resultant carbon-loaded polymer. In this way, the introduction of, for example, about 10 to 35 weight percent carbon, or more preferably 25 to 32 weight percent carbon into the polymer will yield a suitable material that may be used to form conductive carbon-loaded polymer fibers. It will be understood that carbon may be added to other suitable normally non-conductive polymers, such as polypropylene and polyester, to make carbon-loaded polymer fibers, and that these and other carbon-loaded polymer fibers are within the scope of the present invention. Suitable carbon-loaded conductive staple fibers are widely commercially available from a variety of manufacturers.

Still other suitable conductive staple fibers include those made from polymer loaded with antimony-doped tin oxide. The techniques and methods used to introduce the antimony-doped tin oxide into a normally non-conductive polymer are also well known in the art. The antimony-doped tin oxide typically used for this purpose is in the form of a fine powder antimony-doped tin oxide or titanium dioxide powder coated with antimony-doped tin oxide. The antimony doping renders the semi-conductive tin oxide conductive, and the addition of about to 75 weight percent of antimony-doped tin oxide is typically sufficient to render the so loaded polymer conductive. It will be understood that other materials, including other electrically-conductive pigments, may also be loaded into a normally non-conductive polymer to render it conductive, and that conductive staple fibers made from such polymers are within the scope of the invention. However, the electrical properties of conductive polymer blends made using antimony-doped tin oxide and other materials may not be as good as those made using carbon. Thus, carbon-loaded polymers are preferred over polymers made conductive by loading with antimony-doped tin oxide or other materials.

Other suitable conductive staple fibers include those made by coating a normally non-conductive polymer fiber with a solution containing a conductive polymer. Suitable solutions include those containing polyaniline and polypyrrole. Polyaniline-containing solutions are preferred. The techniques and methods used to coat the non-conductive polymer fibers, making the resultant coated fibers conductive, are well known in the art.

Still other suitable conductive staple fibers include those made using inherently-conductive polymer. Inherently-conductive polymers, also commonly termed intrinsically-conductive polymers, are well known in the art and include polyaniline and polypyrrole. Polyaniline is preferred. A plasticized polyaniline complex supplied by Panipol Oy of Finland can be used to make conductive polymer blends using known melt processing techniques. Another supplier of polyaniline, although not in the form of a melt-processible polyaniline complex, is Ormecon of Germany.

Further still, other suitable conductive staple fibers include those fibers that are conductive bicomponent staple fibers. The term bicomponent as used herein to reference fibers includes all fibers, whether in staple or continuous form, made by placing at least two longitudinally-extending constituents in intimate longitudinal contact with each other, the first longitudinally-extending constituent formed of at least one fiber-forming non-conductive polymer and the second longitudinally-extending constituent formed of at least one conductive material. Suitable fiber-forming non-conductive polymers include nylon, polypropylene and polyester. Suitable conductive materials include carbon-loaded polymers, polymers loaded with antimony-doped tin oxide, inherently-conductive (intrinsically-conductive) polymers, and metals. Carbon-loaded polymers and inherently-conductive polymers are preferred.

It will be understood by those of ordinary skill in the art that the term bicomponent fiber embraces a union of longitudinally-extending constituents in a variety of configurations. In one example, the first longitudinally-extending constituent may form a core and the second longitudinally-extending constituent a sheath such that the first constituent is completely encased by the second. Since in this example, the outer shell or sheath material (i.e., the second longitudinally-extending constituent) is electrically-conductive, the fiber as a whole will be conductive.

In a second example of a bicomponent fiber, the first longitudinally-extending constituent may be only partially encased or ensheathed by the second. In this case also, the presence of the conductive second longitudinally-extending constituent on the surface of the fiber will cause the fiber as a whole to be conductive.

In a third example, the (conductive) second longitudinally-extending constituent may take the form of at least one longitudinal stripe partially encapsulated within the first longitudinally-extending constituent. The term partially encapsulated as used herein means that at least part of second longitudinally-extending constituent is exposed on the outer surface of the fiber. Such fibers are often called racing stripe fibers and are commercially available, for example from Solutia, Inc. Such racing stripe fibers may contain from 1 to 5 or more such longitudinal stripes. Fibers made under this example will also be conductive fibers.

In a fourth example, the (non-conductive) first longitudinally-extending constituent may form a sheath completely or almost completely encasing the (conductive) second longitudinally-extending constituent. In this case, measurements of the direct current linear resistance of the fiber become difficult. This is because the measurement probes may sometimes only contact the outer non-conductive shell of the fiber (yielding a linear resistance measurement consistent with a non-conductive fiber), and at other times contact the inner conductive core or the fiber (yielding a linear resistance measurement consistent with a conductive fiber). Such bicomponent fibers, having a sheath of non-conductive material completely or almost completely encasing a core of conductive material, are commonly termed quasi-conductive fibers.

Such bicomponent conductive and quasi-conductive fibers are well-known in the art and are disclosed, for example in U.S. Patents 3,969,559 to Boe and 5,202,185 to Sammuelson. Bicomponent conductive and/or quasi-conductive fibers are also readily available from Solutia, Inc. (under its No-Shock®brand), Dupont, BASF and Kanebo of Japan.

The first embodiment of the present invention, which as noted above includes suitable bicomponent conductive staple fibers, thus includes the bicomponent staple fibers described in the above first, second, and third examples.

In a second embodiment of the present invention, antistatic yarn is made by combining staple fibers and continuous fibers. According to this embodiment, about 35 percent or more by weight of the staple fibers present are conductive staple fibers. Friction spinning, modified to allow the wrapping of a center fiber core with other fibers, (a form of core spinning) is one suitable processing technique that may be used. Thus according to the present invention, there is formed a yarn having a core of continuous fibers surrounded by a sheath of staple fibers. Such yarns are among those commonly termed core spun yarns. The above modified friction spinning techniques, as well as other techniques for combining staple and continuous fibers, are well-known in the art.

The relative proportions of staple fibers and continuous fibers may vary greatly. These proportions are dictated by factors such as the desired strength and other physical properties of the antistatic yarn, the desired amount of static charge dissipation capability, and the limitations of the machinery and techniques used to combine the staple and continuous fibers into a single antistatic yarn. The machinery and techniques for manufacturing a core-spun yarn containing about one-half by weight staple fibers and one-half by weight continuous fibers is well known. However, other proportions and other combination techniques may be used to make antistatic yarns within the scope of the present invention.

According to this second embodiment, suitable conductive staple fibers include metal staple fibers, metal-coated non-conductive polymer staple fibers, carbon-loaded polymer staple fibers, polymer staple fibers loaded with antimony-doped tin oxide, conductive polymer solution-coated non-conductive polymer staple fibers, inherently-conductive polymer staple fibers, and bicomponent conductive staple fibers. Again, metal and metal coated staple fibers are least preferred, and carbon-loaded polymer staple fibers are preferred over those polymer staple fibers loaded with antimony-doped tin oxide or other materials.

According to this second embodiment, any suitable continuous fibers may be used, including conductive fibers, quasi-conductive fibers, and non-conductive fibers. Continuous conductive fibers are thought to be preferred because they are thought to have the ability to more easily transfer static charge from a localized area of charge accumulation to the conductive and/or quasi-conductive staple fibers present along the entire length of the antistatic yarn.

Second Set of Embodiments: In still another embodiment of the present invention, the antistatic yarn is made entirely from staple fibers, wherein about 35 percent or more by weight of the fibers are quasi-conductive fibers. The balance of staple fibers, if any, may be non-conductive staple fibers. As with the First Set of Embodiments discussed above, standard processing techniques, such as ring spinning, may be employed to make antistatic yarn according to this embodiment.

The use of quasi-conductive staple fibers may offer advantages in terms of ease of processing the fiber blend into yarn. This is because quasi-conductive fibers, with their outer sheath of non-conductive polymer, have processing characteristics that may be somewhat different from those having an outer sheath of a conductive material. Also, the use of quasi-conductive staple fibers alone or in conjunction with conductive staple fibers will afford some control over the linear resistance of the resultant yarn, thereby helping to minimize or eliminate incendiary static discharges.In another embodiment of the present invention, antistatic yarn is made by combining staple fibers and continuous fibers. According to this embodiment, about 35 percent or more by weight of the staple fibers present are quasi-conductive staple fibers. Again, as with the First Set of Embodiments discussed above, standard processing techniques such as modified friction spinning may be employed, and the relative proportions between the staple fibers and the continuous fibers may be varied greatly. Again, any suitable continuous fibers may be used, including conductive fibers, quasi-conductive fibers, and non-conductive fibers. For the reasons disclosed above, continuous conductive fibers are thought to be preferred.Third Set of EmbodimentsIn another embodiment of the present invention, the antistatic yarn is made entirely from staple fibers, wherein about 35 percent or more by weight of the fibers are a mixture of conductive and quasi-conductive fibers. The balance of staple fibers, if any, may be non-conductive staple fibers. As with the First Set of Embodiments discussed above, standard processing techniques may be employed.

Once again, the use of some quasi-conductive staple fibers may offer advantages in terms of ease of processing the fiber blend into yarn and affording some control over the linear resistance of the resultant yarn.In still another embodiment of the present invention, antistatic yarn is made by combining staple fibers and continuous fibers. According to this embodiment, about 35 percent or more by weight of the staple fibers present are a mixture of conductive and quasi-conductive fibers. Once again, standard spinning techniques may be employed, the relative proportions between the staple fibers and the continuous fibers may be varied greatly, and any suitable continuous fibers may be used, including conductive fibers, quasi-conductive fibers, and non-conductive fibers. For the reasons disclosed above, continuous conductive fibers are here again thought to be preferred.

Other Embodiments: In another embodiment of the present invention, the antistatic yarns may be incorporated into carpets. It is understood that carpets generally consist of one or more layers of a backing material and a plurality of carpet piles, the carpet piles bonded to and arising up from the topmost backing material. Much work in the prior art has been directed to the development of carpets with antistatic properties. As will be appreciated by those of ordinary skill in the art, the antistatic yarns disclosed above may be incorporated using well-known methods into the carpets piles, into one or more of the carpet backing material layers, or into both the carpet piles and one or more of the carpet backing material layers.

In another embodiment of the present invention, the antistatic yarns may be incorporated into fabrics. Such fabrics include those used to make apparel, such as clothing, and those used in industrial applications, such as flexible intermediate bulk containers (FIBCs). For example, such FIBCs are described in U.S. Patent Nos. 5,512,355 and 5,478,154, the entire subject matter of which is incorporated herein by reference.

Various methods of incorporating the antistatic yarns disclosed above are available in the prior art. For the purposes of the present invention, the antistatic yarns may be woven into the fabric of the FIBC so that the yarns are parallel to each other, or so that the yarns form a grid configuration. Any suitable spacing between the antistatic fibers may be employed. Typically, however, it is preferred that the spacing between antistatic yarns range from about 0.5 to 2 inches. The antistatic yarns may be grounded, as is taught in the prior art, or optionally, the antistatic yarns may be ungrounded. In this latter case, it is preferred that a static dissipative coating also be applied to the FIBC fabric.

Those skilled in the art will appreciate that other embodiments are possible according to the present invention, and that the scope of the present invention is not limited to the specific embodiments disclosed herein.

Example 1 A reference yarn consisting of bicomponent conductive continuous fibers was prepared using standard techniques. The yarn consisted of 40 filaments and had a denier of 350. The bicomponent fibers consisted of a sheath of conductive polymer (nylon loaded with about 30 percent by weight carbon) completely surrounding a core of non-conductive nylon.

Example 2 An antistatic yarn according to this invention, consisting of 50 weight percent conductive staple fibers and 50 weight percent non-conductive nylon staple fibers, was produced via a standard ring-spinning technique. The conductive staple fibers were obtained starting from an 18 denier, 2 continuous fiber yarn, wherein each filament was a bicomponent conductive racing stripe fiber having 3 longitudinal stripes of a carbon-loaded conductive polymer constituent on the surface of a non-conductive nylon constituent (No-Shock® product no. 18-2E3N yarn, available from Solutia, Inc.). This starting material was twice drawn, to 4.5 denier per filament, and then cut to a fiber length of 1.5 inches before being ring spun with the non-conductive nylon staple fibers (3.5 denier, 1.5 inch fiber length). The total denier of the antistatic yarn was 471.

Example 3 An antistatic yarn according to this invention, consisting of a core of continuous conductive fibers surrounded by a sheath of conductive staple fibers, was produced via a standard DREF core spinning technique. Equal portions by weight of core continuous fibers and sheath staple fibers were used. The core continuous conductive fibers were the same bicomponent conductive-sheath, non-conductive core fibers described in Example 1. The surrounding conductive staple fibers were the same twice-drawn 4.5 denier per filament, 1.5 inch cut length, 3-racing stripe fibers described in Example 2. The total denier of the formed antistatic yarn was 632.

Example 4 An antistatic yarn according to this invention, consisting of a core of continuous conductive fibers surrounded by a sheath of staple fibers was produced via standard core spinning techniques. Again, equal portions by weight of core continuous fibers and sheath staple fibers were used. The core continuous conductive fibers were again the same bicomponent conductive-sheath, non-conductive core fibers described in Example 1. The surrounding staple fibers consisted of the 50/50 blend of conductive and non-conductive staple fibers used in Example 2. The total denier of the formed antistatic yarn was 616.Test Results Table I below shows some of the physical properties of the exemplary antistatic yarns made according to the present invention. These yarns have physical properties suitable for incorporation into fabrics, carpets, and other items.

| Antistatic Yarn | Denier | Break Strength (G) | Elongation at Breaking (%) | Linear Resistance of Yarn (ohm/cm) |
|---|---|---|---|---|
| Example 2 | 471 | 912 | 28.5 | 5.5 x 10⁹ |
| Example 3 | 632 | 703 | 45.9 | 5.9 x 10⁵ |
| Example 4 | 616 | 927 | 28.3 | 3.6 x 10⁵ |

In one experiment to test the antistatic properties of the present invention, the static dissipation time of the antistatic yarn of Example 2 was measured. Test conditions were 23 degrees Celsius and 50 % relative humidity. A length of the sample yarn (about 0.5 meters) was prepared by manually wrapping it around a non-conductive piece of polypropylene FIBC fabric in such a way that the sample yarn coils did not touch each other, but rather were spaced about 1 centimeter apart from each other. The sample yarn was then charged to 5000 volts. Next, the sample yarn was grounded, and an electrostatic voltmeter was used to measure the time required for the electric field around the sample yarn to decay to 10 percent of its initial value. Static decay time measurements were made using a Static Decay Meter model 406 D from Electrotech Systems, Inc., Glenside, PA 19038. This method is consistent with Federal Test Method Standard 101B, Method 4046.

The antistatic yarn of Example 2 was found to have a static dissipation time of 0.01 seconds or less. This compares with a typical static dissipation time of several minutes or more for yarns made solely from non-conductive fibers. This shorter static dissipation time it thought to be surprisingly short, given the yarn"s relatively high linear resistance. This combination of short static dissipation time and relatively high linear resistance is a good combination of properties. That is, the short static dissipation time is indicative of the yarn"s ability to dissipate static electricity quickly via lower-energy, non-incendiary discharges, and the relatively high linear resistance is indicative of the yarn"s ability to dissipate static electricity without producing dangerous higher-energy, sparking discharges.

In another experiment to test the antistatic properties of the present invention, the corona current of the exemplary yarns was measured as a function of applied voltage. This test was performed by first placing a one-inch length of the sample yarn into a grounded Faraday cup, the upper end of the sample yarn being attached to a high voltage source and the lower end of the sample yarn hanging about 0.25 inches above the bottom of the cup. The cup was connected to ground through a sensitive current meter. Various voltages were applied across the yarn, and the current traveling from the yarn across the air gap to the cup was measured. A more detailed description of this test apparatus and its operation may be found in the following reference, the disclosure of which is incorporated herein by reference: Kessler, LeAnn and Fisher, W. Keith, A study of the electrostatic behavior of carpets containing conductive yarns, J. Electrostatics, 39 (1997) pp. 260-261.

Voltages of up to 5000 volts were applied, and the corona current flowing from the sample yarn across the air gap was observed and recorded. Table II shows the results for the exemplary antistatic yarns. Test conditions were 23.8 degrees Celsius and 55 % relative humidity. The test apparatus was also operated without a yarn in order to leak test the apparatus. Under this condition, it was found that only small quantities of current would flow between the high voltage source and the grounded Faraday cup. For each applied voltage, the corrected current shown in Table II was calculated by subtracting the leak current from the current measured.

| | | | | |
|---|---|---|---|---|
| | Applied Voltage: 4000 V | Applied Voltage: 4000 V | Applied Voltage: 5000 V | Applied Voltage: 5000 V |
| Antistatic Yarn | Measured Current (amps) | Corrected Current (amps) | Measured Current (amps) | Corrected Current (amps) |
| None (leak test) | 0.1 x 10⁻⁴ | N/A | 0.15 x 10⁻⁴ | N/A |
| Example 1 | 0.1 x 10⁻³ | 0.9 x 10⁻⁴ | 0.22 x 10⁻³ | 0.205 x 10⁻³ |
| Example 2 | 0.4 x 10⁻⁴ | 0.3 x 10⁻⁴ | 0.7 x 10⁻⁴ | 0.55 x 10⁻⁴ |
| Example 3 | 0.1 x 10⁻³ | 0.9 x 10⁻⁴ | >>1.0 x 10⁻³ | >>1.0 x 10⁻³ |
| Example 4 | 0.45 x 10⁻⁴ | 0.35 x 10⁻⁴ | | |

The yarn of Example 2 showed significant corona current, despite its high linear resistance. The yarn of Example 2 also exhibited a visible glow from its fiber ends at an applied voltage above about 4500 volts when the laboratory lights were turned out.

At lower applied voltages, the yarns of Examples 3 and 4 demonstrated corona currents similar to those of yarns made entirely from conductive continuous fibers.

However, small current spikes, measuring up to about 0.1 x 10⁻³ amps, were observed in the yarn of Example 4 as the applied voltage was increased above about 3000 volts. Very strong current spikes, measuring up to about 2 x 10⁻³ amps, were observed in the yarns of Examples 3 and 4 at applied voltages between 4000 and 5000 volts. It is thought that these current spikes are associated with the onset of a strong corona discharge along the entire length of the antistatic yarn. Thus, it is thought that these core-spun yarns, having cores of conductive continuous filaments and sheaths of conductive staple fibers, may be particularly useful yarns for many antistatic applications.

Claims

1.A yarn comprising a plurality of staple fibers chosen from the group consisting of conductive staple fibers, quasi-conductive staple fibers and mixtures of conductive and quasi-conductive staple fibers, the fibers from this group making up at least about 35 percent by weight of the staple fibers in the yarn.

2.The yarn of claim 1, wherein the plurality of staple fibers from said group makes up at least about 50 percent by weight of the staple fibers in the yarn.

3.The yarn of claim claim11claim1, wherein the plurality of staple fibers from said group makes up substantially 100 percent of the staple fibers in the yarn.

4.The yarn of claim 1, wherein the plurality of staple fibers comprises at least some conductive staple fibers.

5.The yarn of claim 4, wherein the individual conductive staple fibers have a DC linear resistance less than about 10⁹ ohms per centimeter.

6.The yarn of claim 5, wherein at least some of the conductive staple fibers comprise metal.

7.The yarn of claim 5, wherein at least some of the conductive staple fibers comprise non-conductive polymer and are coated with metal.

8.The yarn of claim 5, wherein at least some of the conductive staple fiberares comprise carbon-loaded polymer.

9.The yarn of claim 5, wherein at least some of the conductive staple fibers comprise polymer loaded with antimony-doped tin oxide.

10.The yarn of claim 5, wherein at least some of the conductive staple fibers comprise non-conductive polymer and are solution-coated with one or more electrically-conductive polymers.

11.The yarn of claim 5, wherein at least some of the conductive staple fibers comprise inherently-conductive polymer.

12.The yarn of claim 5, wherein at least some of the conductive staple fibers are bicomponent staple fibers.

13.The yarn of claim 12, wherein the individual bicomponent staple fibers each comprise
a first longitudinally-extending constituent formed of at least one fiber-forming non-conductive polymer; and
a second longitudinally-extending constituent formed of at least one conductive material,
wherein the second longitudinally-extending constituent is in longitudinal contact with the surface of the first longitudinally-extending constituent.

14.The yarn of claim 11, wherein the second longitudinally-extending constituent comprises conductive polymer.

15.The yarn of claim 12, wherein the first longitudinally-extending constituent forms a core of the fiber and the second longitudinally-extending constituent forms a sheath around at least part of the circumference of the core.

16.The yarn of claim 15, wherein the second longitudinally-extending constituent forms a sheath around the entire circumference of the core.

17.The yarn of claim 16, wherein said bicomponent conductive staple fibers make up at least about 50 percent by weight of the staple fibers in the yarn.

18.The yarn of claim 16, wherein said bicomponent conductive staple fibers make up substantially 100 percent of the staple fibers in the yarn.

19.The yarn of claim 14, wherein the second longitudinally-extending constituent is in the form of at least one longitudinal stripe partially encapsulated within the first longitudinally-extending constituent.

20.The yarn of claim 19, wherein said bicomponent conductive staple fibers make up at least about 50 percent by weight of the staple fibers in the yarn.

21.The yarn of claim 19, wherein said bicomponent conductive staple fibers make up substantially 100 percent of the staple fibers in the yarn.

22.The yarn of claim 1, wherein the plurality of staple fibers comprises at least some are quasi-conductive staple fibers.

23. claim1323claim13.The yarn of claim 22, wherein at least some of the quasi-conductive staple fibers are bicomponent staple fibers.

24.The yarn of claim 23, wherein the individual bicomponent staple fibers each comprise
a first longitudinally-extending constituent formed of at least one fiber-forming non-conductive polymer; and
a second longitudinally-extending constituent formed of at least one conductive material,
wherein the second longitudinally-extending constituent is in longitudinal contact with the surface of the first longitudinally-extending constituent.

25.The yarn of claim 24, wherein the second longitudinally-extending constituent is comprises conductive polymer.

26.The yarn of claim 25, wherein the second longitudinally-extending constituent forms a core of the fiber and the first longitudinally-extending constituent forms a sheath around at least part of the circumference of the core.

27.The yarn of claim 26, wherein the first longitudinally-extending constituent forms a sheath around the entire circumference of the core.

28.The yarn of claim 27, wherein said bicomponent quasi-conductive staple fibers make up at least about 50 percent by weight of the staple fibers in the yarn.

29.The yarn of claim 27, wherein said bicomponent quasi-conductive staple fibers make up substantially 100 percent of the staple fibers in the yarn.

30.A fabric comprising a plurality of yarns, at least some of the yarns comprising a plurality of staple fibers chosen from the group consisting of conductive staple fibers, quasi-conductive staple fibers and mixtures of conductive and quasi-conductive staple fibers, the fibers from this group making up at least about 35 percent by weight of the staple fibers in those yarns in which said plurality of staple fibers are incorporated.

31.The fabric of claim 30, wherein the plurality of staple fibers from said group makes up at least about 50 percent by weight of the staple fibers in those yarns in which said plurality of staple fibers are incorporated.

32.The fabric of claim 30, wherein the plurality of staple fibers from said group makes up substantially 100 percent of the staple fibers in those yarns in which said plurality of staple fibers are incorporated.

33.The fabric of claim 30, wherein the plurality of staple fibers comprises at least some conductive staple fibers.

34.The fabric of claim 33, wherein the individual conductive staple fibers have a DC linear resistance less than about 10⁹ ohms per centimeter.

35.The fabric of claim 34, wherein at least some of the conductive staple fibers comprise metal.

36.The fabric of claim 34, wherein at least some of the conductive staple fibers comprise non-conductive polymer and are coated with metal.

37.The fabric of claim 34, wherein at least some of the conductive staple fibers comprise carbon-loaded polymer.

38.The fabric of claim 34, wherein at least some of the conductive staple fibers comprise polymer loaded with antimony-doped tin oxide.

39.The fabric of claim 34, wherein at least some of the conductive staple fibers comprise non-conductive polymer solution-coated with one or more electrically-conductive polymers.

40.The fabric of claim 34, wherein at least some of the conductive staple fibers comprise inherently-conductive polymer.

41.The fabric of claim 34, wherein at least some of the conductive staple fibers are bicomponent staple fibers.

42.The fabric of claim 41, wherein the individual bicomponent staple fibers each comprise
a first longitudinally-extending constituent formed of at least one fiber-forming non-conductive polymer; and
a second longitudinally-extending constituent formed of at least one conductive material,
wherein the second longitudinally-extending constituent is in longitudinal contact with the surface of the first longitudinally-extending constituent.

43.The fabric of claim 42, wherein the second longitudinally-extending constituent comprises conductive polymer.

44.The fabric of claim 43, wherein the first longitudinally-extending constituent forms a core of the fiber and the second longitudinally-extending constituent forms a sheath around at least part of the circumference of the core.

45.The fabric of claim 44, wherein the second longitudinally-extending constituent forms a sheath around the entire circumference of the core.

46.The fabric of claim 44, wherein said bicomponent conductive staple fibers make up at least about 50 percent by weight of the staple fibers in those yarns in which the bicomponent conductive staple fibers are incorporated.

47.The fabric of claim 44, wherein said bicomponent conductive staple fibers make up substantially 100 percent of the staple fibers in those yarns in which the bicomponent conductive staple fibers are incorporated.

48.The fabric of claim 43, wherein the second longitudinally-extending constituent is in the form of at least one longitudinal stripe partially encapsulated within the first longitudinally-extending constituent.

49.The fabric of claim 48, wherein said bicomponent conductive staple fibers make up at least about 50 percent by weight of the staple fibers in those yarns in which the bicomponent conductive staple fibers are incorporated.

50.The fabric of claim 48, wherein said bicomponent conductive staple fibers make up substantially 100 percent of the staple fibers in those yarns in which the bicomponent conductive staple fibers are incorporated.

51.The fabric of claim 30, wherein the plurality of staple fibers comprises at least someare quasi-conductive staple fibers.

52.The fabric of claim 51, wherein at least some of the quasi-conductive staple fibers are bicomponent staple fibers.

53.The fabric of claim 52, wherein the individual bicomponent staple fibers each comprise
a first longitudinally-extending constituent formed of at least one fiber-forming non-conductive polymer; and
a second longitudinally-extending constituent formed of at least one conductive material,
wherein the second longitudinally-extending constituent is in longitudinal contact with the surface of the first longitudinally-extending constituent.

54.The fabric of claim 53, wherein the second longitudinally-extending constituent comprises conductive polymer.

55.The fabric of claim 54, wherein the second longitudinally-extending constituent forms a core of the fiber and the first longitudinally-extending constituent forms a sheath around at least part of the circumference of the core.

56.The fabric of claim 55, wherein the first longitudinally-extending constituent forms a sheath around the entire circumference of the core.

57.The fabric of claim 54, wherein said bicomponent quasi-conductive staple fibers make up at least about 50 percent by weight of the staple fibers in those yarns in which the quasi-conductive staple fibers are incorporated.

58.The fabric of claim 54, wherein said bicomponent quasi-conductive staple fibers make up substantially 100 percent of the staple fibers in those yarns in which the quasi-conductive staple fibers are incorporated.

59.A carpet comprising
at least one backing layer and
a plurality of carpet piles bonded thereto,
at least some of the piles or at least one backing layer comprising yarn that comprises a plurality of staple fibers chosen from the group consisting of conductive staple fibers, quasi-conductive staple fibers and mixtures of conductive and quasi-conductive staple fibers, the staple fibers from this group making up at least about 35 percent by weight of the staple fibers in the said yarn.

60.The carpet of claim 59, wherein the plurality of staple fibers from said group makes up at least 50 percent by weight of the staple fibers in the said yarn.

61.The carpet of claim 59, wherein the plurality of staple fibers from said group makes up substantially 100 percent of the staple fibers the said yarn.

62.The carpet of claim 59, wherein the plurality of staple fibers comprises at least some conductive staple fibers.

63.The carpet of claim 62, wherein the individual conductive staple fibers have a DC linear resistance less than about 10⁹ ohms per centimeter.

64.The carpet of claim 63, wherein at least some of the conductive staple fibers comprise metal.

65.The carpet of claim 63, wherein at least some of the conductive staple fibers are comprise non-conductive polymer and are coated with metal.

66.The carpet of claim 63, wherein at least some of the conductive staple fibers comprise carbon-loaded polymer.

67.The carpet of claim 63, wherein at least some of the conductive staple fibers comprise polymer loaded with antimony-doped tin oxide.

68.The carpet of claim 63, wherein at least some of the conductive staple fibers are comprise non-conductive polymer and are solution-coated with one or more electrically-conductive polymers.

69.The carpet of claim 63, wherein at least some of the conductive staple fibers comprise inherently-conductive polymer.

70.The carpet of claim 63, wherein at least some of the conductive staple fibers are bicomponent staple fibers.

71.The yarn of claim 70, wherein the individual bicomponent staple fibers each comprise
a first longitudinally-extending constituent formed of at least one fiber-forming non-conductive polymer; and
a second longitudinally-extending constituent formed of at least one conductive material,
wherein the second longitudinally-extending constituent is in longitudinal contact with the surface of the first longitudinally-extending constituent.

72.The carpet of claim 71, wherein the second longitudinally-extending constituent comprises conductive polymer.

73.The carpet of claim 72, wherein the first longitudinally-extending constituent forms a core of the fiber and the second longitudinally-extending constituent forms a sheath around at least part of the circumference of the core.

74.The carpet of claim 73, wherein the second longitudinally-extending constituent forms a sheath around the entire circumference of the core.

75.The carpet of claim 74, wherein said bicomponent conductive staple fibers make up at least 50 percent by weight of the staple fibers the said yarn.

76.The carpet of claim 74, wherein said bicomponent conductive staple fibers make up substantially 100 percent of the staple fibers the said yarn.

77.The carpet of claim 72, wherein the second longitudinally-extending constituent is in the form of at least one longitudinal stripe partially encapsulated within the first longitudinally-extending constituent.

78.The carpet of claim 77, wherein said bicomponent conductive staple fibers make up at least about 50 percent by weight of the staple fibers said yarn.

79.The carpet of claim 77, wherein said bicomponent conductive staple fibers make up substantially 100 percent of the staple fibers said yarn.

80.The carpet of claim 59, wherein the plurality of staple fibers comprises at least some are quasi-conductive staple fibers.

81.The carpet of claim 80, wherein at least some of the quasi-conductive staple fibers are are bicomponent staple fibers.

82.The carpet of claim 81, wherein the individual bicomponent staple fibers each comprise
a first longitudinally-extending constituent formed of at least one fiber-forming non-conductive polymer; and
a second longitudinally-extending constituent formed of at least one conductive material,
wherein the second longitudinally-extending constituent is in longitudinal contact with the surface of the first longitudinally-extending constituent.

83.The carpet of claim 82, wherein the second longitudinally-extending constituent comprises conductive polymer.

84.The carpet of claim 83, wherein the second longitudinally-extending constituent forms a core of the fiber and the first longitudinally-extending constituent forms a sheath around at least part of the circumference of the core.

85.The carpet of claim 84, wherein the first longitudinally-extending constituent forms a sheath around the entire circumference of the core.

86.The carpet of claim 85, wherein said bicomponent quasi-conductive staple fibers make up at least about 50 percent by weight of the staple fibers the said yarn.

87.The carpet of claim 85, wherein said bicomponent quasi-conductive staple fibers make up substantially 100 percent of the staple fibers the said yarn.

88.A fiber blend for use in antistatic yarns, the blend comprising a plurality of staple fibers comprising non-conductive staple fibers and staple fibers chosen from the group consisting of conductive staple fibers, quasi-conductive staple fibers and mixtures of conductive and quasi-conductive staple fibers, the fibers from this group making up at least about 35 percent by weight of the staple fibers in the fiber blend.

89. The fiber blend of claim 88, wherein the plurality of staple fibers comprises at least some conductive staple fibers.

90. The fiber blend of claim 89, wherein the individual conductive staple fibers have a DC linear resistance less than about 10⁹ ohms per centimeter.

91. The fiber blend of claim 90, wherein at least some of the conductive staple fibers comprise metal.

92. The fiber blend of claim 90, wherein at least some of the conductive staple fibers comprise inherently-conductive polymer.

93.The fiber blend of claim 90, wherein at least some of the conductive staple fibers are bicomponent staple fibers.

94.The fiber blend of claim 93, wherein the individual bicomponent staple fibers each comprise
a first longitudinally-extending constituent formed of at least one fiber-forming non-conductive polymer; and
a second longitudinally-extending constituent formed of at least one conductive material,
wherein the second longitudinally-extending constituent is in longitudinal contact with the surface of the first longitudinally-extending constituent.

95.The fiber blend of claim 94, wherein the second longitudinally-extending constituent comprises conductive polymer.

96.The fiber blend of claim 95, wherein the first longitudinally-extending constituent forms a core of the fiber and the second longitudinally-extending constituent forms a sheath around at least part of the circumference of the core.

97.The fiber blend of claim 93, wherein the second longitudinally-extending constituent is in the form of at least one longitudinal stripe partially encapsulated within the first longitudinally-extending constituent.

98.The fiber blend of claim 88, wherein the plurality of staple fibers comprises at least some are quasi-conductive staple fibers.

99.The fiber blend of claim 98, wherein at least some of the quasi-conductive staple fibers are bicomponent staple fibers.

100.A fiber blend for use in antistatic yarns, the blend comprising a mixture of conductive and quasi-conductive staple fibers.
